(19) United States
(12) Patent Application Publication
(10) Pub. No.: US 2011/0241838 A1
(43) Pub. Date: Oct. 6, 2011

(54) SYSTEM, METHOD, AND APPARATUS FOR RFID, EMULATED RFID AND RFID-LIKE BASED ENABLEMENT AND PRIVILEGE ALLOCATION

(76) Inventor: Carl Edward Wischmeyer, Marion, IA (US)

(21) Appl. No.: 13/086,892

(22) Filed: Apr. 14, 2011

Related U.S. Application Data
(60) Provisional application No. 61/402,674, filed on Sep. 2, 2010.

(51) Int. Cl. G06K 7/01

(52) U.S. Cl. 340/10.1

(57) ABSTRACT

A method of emulating a physical RFID tag includes storing in a machine readable memory an RFID tag encoding, communicating the RFID tag encoding to a system, and using the RFID tag encoding at the system to emulate the physical RFID tag and perform a function without emulating an RFID transponder signal.

### CROSS-REFERENCE TO RELATED APPLICATIONS

This application claims priority to U.S. Provisional patent application Ser. No. 61/402,674, entitled SYSTEM, METHOD, AND APPARATUS FOR RFID AND EMULATED RFID BASED PRIVILEGE ALLOCATION, filed Sep. 2, 2010 and is hereby incorporated in its entirety.

### FIELD OF THE INVENTION

The present invention relates to the use of wireless technology for providing security, theft protection, and privilege allocation for a wide range of protected equipment that can be turned on and off, and/or operated at various levels of performance and/or privilege. The novel feature of the present invention is the use of emulated RFID as the wireless technology.

### PROBLEMS IN THE ART

Wireless technologies are used for a variety of functions, such as permitting access to secure area to inventory checking to conveying simple information such as tire pressures on an automobile.

These kinds of applications, in general, have several characteristics. First, the wireless technology is the primary and/or obvious way of enabling the device or providing privilege or providing information. Secondly, the wireless technology is used once or occasionally per session. Third, these technologies are often external, “add-on” devices and not necessarily tightly integrated into the protected device. Fourth, the wireless device often has to be placed in contact with a reading device.

There are a number of areas in which there exist needs for security, theft protection, and privilege allocation beyond existing, non-wireless techniques. Security often means physical access to certain areas, but it can also mean security of data access and security of operating machinery. For theft protection, automobile theft and carjacking are to some degree protected by theft protection systems and remote tracking, but such systems are visible and often easily defeated. High value electronic components, such as consumer products (flat screen TVs, home theater systems, computers, and cameras) usually have little or no theft protection. Office and industrial equipment is also susceptible to theft. Privilege allocation can include access to information, such as confidential financial, business, or classified information; television “parental privilege;” or levels of performance, such as restrictions on automotive performance based on who is driving the car, whether it be the owner, a service shop, or a juvenile family member.

One example of prior art is Audi's wireless tags that substitute for a key, and allow the user to operate the car in the presence of the tag. However, the tag encryption is changed with every use, and the tag is used as part of, not in addition to, a normal key. Another example of prior art is the Armatix Smartgun, in which a fingerprint reader on a wristwatch wirelessly enables a handgun to be fired only when the gun is in the immediate proximity of the wristwatch.

What is needed is a system, method, and apparatus that uses wireless technology, such as, but not limited to RFID, for providing security, theft protection, and privilege allocation for a wide range of equipment that can be turned on and off, and/or that can be operated at various levels of performance and/or privilege, with operation and privilege possibly varying according to which operator(s) are present and also according to environmental conditions, including the required absence of certain assets.

### SUMMARY OF THE INVENTION

The present invention, in its simplest embodiment, comprises a device to be managed; a host cooperative wireless device (such as an EPCglobal [Electronic Product Code] interrogator) communicating with the device to be managed; and a nearby inconspicuous remote cooperative wireless device, such as an EPCglobal Class 1 RFID tag. (The term “RFID tag” will be used from here on to mean the remote cooperative wireless device, whether that tag be an RFID tag of whatever class, or some other device that communicates via cell phone, Wi-Fi, UMA [unlicensed mobile access]/Wi-Fi, Bluetooth, Iridium or other satellite-based system, or other means, optical, electrical or acoustical; or is embedded in a web page, pop-up window, downloaded application, cookie, or similar electronic transmission such as to a computer, iPad or similar device, PDA, smart phone, or other portable electronic device, whether that embedding is transparent to or displayed to the reader of the web page or similar electronic transmission; or is read by a bar code reader; or is given as a character string to be manually entered; uses RFID protocols, algorithms, and data structures or any similar protocols and formats; or any combination of RFID tag(s), emulated RFID tag(s) and RFID-like tags, as known to one skilled in the art; or conveyed in some other manner known to one skilled in the art.) The host device, only upon detecting the presence of the RFID tag or emulated RFID tag, permits operations of the device to be managed by normal controls of the sort that would be present in the absence of this device. The location and possibly the very existence of the remote wireless device would not necessarily be known to one trying to inappropriately use the protected device.

Alternatively, the present invention, comprises a device to be managed; a host cooperative wireless device (such as an EPCglobal interrogator) communicating with the device to be managed; and a nearby inconspicuous remote cooperative wireless device, such as an emulated EPCglobal Class 1 RFID tag. (The term “emulated RFID tag” will be used from here on to mean the remote cooperative wireless device, whether that tag be an emulated RFID tag of whatever class, or some other device that communicates vial cell phone, UMA/Wi-Fi, Bluetooth, Iridium or other satellite-based system, or other means, optical, electrical or acoustical; or is embedded in a web page, pop-up window, downloaded application, cookie, or similar electronic transmission such as to a computer, iPad or similar device, PDA, smart phone, or other portable electronic device, whether that embedding is transparent to or displayed to the reader of the web page or similar electronic transmission; or is read by a bar code reader; or is given as a character string to be manually entered, or any other manipulation of user interface elements, or any other manual entry; or any combination of RFID tag(s) and emulated RFID tag(s), as known to one skilled in the art; or conveyed in some other manner known to one skilled in the art. The host device, only upon detecting the presence of the emulated RFID tag, permits operations of the device to be managed by normal controls of the sort that would be present in the absence of this device, but the presence of the RFID tag and/or the information read from the RFID tag allows the device to be operated at different levels of privilege and performance. The location and possibly the very existence of the remote wireless device would not necessarily be known to one trying to inappropriately use the protected device.

Throughout the present invention, the term enablement means that the emulated RFID tag allows the protected device's on/off switch to function normally. The presence of the emulated RFID tag could be checked at initial operation, during continued operation, or at wakeup. If the emulated RFID tag is absent or is removed, the protected device will not function normally, and, as described below, any number of actions may be taken. Enablement can also be determined by logical combinations of emulated RFID tags (including absent tags) and external data, such as data from external sensors, stored electronic data of all sorts, manual inputs, date, and time. Enablement permits the protected device or system to operate, whether that operation be initial or continued operation, or wakeup; and regardless of the actions taken when enablement is disallowed.

Throughout the present invention, the term privilege means that the protected system will operate in a mode determined by the detection of an emulated RFID tag or a combination of emulated RFID tags. Such a mode is called privilege because the emulated RFID tag(s) communicate the operating privileges granted to the operators bearing the emulated RFID tags. The permitted functionalities when a device is operating in such modes may or may not be proper subsets. Privilege can be determined at device startup, or repeatedly while the device is operated. Privilege can also be determined by logical combinations of emulated RFID tags (including absent tags) and external data, such as data from external sensors, stored electronic data of all sorts, manual inputs, date, and time.

Enablement and privilege are not the same concept. For example, an instructor or supervisor may have privilege, but not enablement. One example is that a clerk may have enablement to operate a cash register, but the supervisor has privilege to override. However, the supervisor cannot operate that cash register when it has been enabled by another person.

In the first preferred embodiment, the host device is an asset either of high value or in which misuse or loss has high consequential costs, or both, with one or more built-in digital processors, connected to an RFID transmitter, which may be embedded. When the host detects and/or continues to detect the tag, the device is enabled. This capability is referred to in this document as an “enabling tag.” This simplest implementation is basically an EPCglobal inventory function with the device enabled when the tag is detected.

In general, an enabling tag is hidden in a fixed location, and the enabled device works only in the presence of the enabling tag. However, enabling tags can also be carried on the operator's person for other applications described below. An enabling tag could be embodied in an identity card, in a card carried in the wallet, in a lanyard, in a utility belt, key ring, in jewelry, safety glasses or other safety equipment, any other specialized apparel or equipment appropriate to the job being performed, or in any kind of packaging. Or a fixed location tag could be hidden in the same support structure or furniture; room; building; or regions as the enabled device, so that the device would only be enabled when communications were established with the tag.

In the second preferred embodiment, the interrogator (that term will be used from here on to mean not only an interrogator in the EPCglobal sense, but any system which is capable of detecting an RFID or emulated RFID tag by whatever means) detects the presence of a tag that permits operation of the host device at a certain level of privilege or performance. In this embodiment, referred to below as a “privilege tag,” the privilege tag is normally carried by the operator. A privilege tag could be embodied in an identity card, in a card carried in the wallet, in a lanyard, in a utility belt, key ring, in jewelry, safety glasses or other safety equipment, any other specialized apparel or equipment appropriate to the job being performed, or in any kind of packaging. Again, this embodiment is basically an RFID inventory function with appropriate level(s) of privilege granted when the tag is detected.

As discussed below in detail, there are innumerable variations and combinations of enabling tags, privilege tags, protected systems, and other elements. The embodiments include one to one, one to many, many to one, and many to many relationships between protected systems (and sub-systems), and tags of all sorts, including single tags that work in concert with disjoint systems. Also included are systems which re/program tags for different systems, privileges, operating conditions, and duration of validity, including web-based and other remote re/programming systems.

The invention also covers other means of communication between the based system and the detected system. For example, a cell phone tower or femto-tower could be the interrogator, and a cell phone could be the detected device; or a UMA/Wi-Fi system could detect a remote device; or Bluetooth. Multiple simultaneous systems could be required, for reliability or for security or for other reasons.

The information content is not necessarily limited to detection of a device, analogous to an inventory function. The detected device could store information for security (such as a private key or a public key), information for billing, for logging hours and observing maximum permitted time accumulations, privileges, qualifications, costs, resource allocation, tolerated emissions and discharge, and other information. Similarly, the host device could send to the detected device information on operating environment conditions, operating limitations, threats and hazards, status, news, information, software updates, commands, orders, and security questions to verify the identity of the operator. This information content can be conveyed in fixed format binary, in clear text, XML, binary XML, and other formats known to one skilled in the art. Normally, data would be transported over TCP/IP (Transmission Control Protocol/Internet Protocol) at the application layer, but the tag could contain address data—where the tag data should be processed—as in the TCP/IP transport layer.

Frequently the interrogator will have a list of individual RFID tags that will enable operation and/or grant privilege. This is not necessarily the case, however, as the interrogator may be programmed to enable operation and/or grant privilege when an RFID tag or emulated RFID tag is detected that identifies the (possibly unknown individual) RFID tag as belonging to a known affinity group. Such affinity groups may include: holders of license, certificates, diplomas, security clearance, need to know, or those meeting certain levels of experience; those with known medical conditions and/or drug prescriptions; maintenance and repair organizations; those with certain criminal records or parole conditions; those who meet requirements for training, recent experience, and current license; those free of disqualifying conditions, whether those be medical, security, nationality, need to know, age, or other; within a company, employees, senior executives, vendors, customers, and members of customer loyalty programs; club, organization, or family members.

It may also be the case that the RFID tags describe the operating environment for certain dangerous devices. Such information conveyed by the RFID tags includes but is not limited to the readiness of emergency equipment, safety equipment, blast protectors, electromagnetic protections of all sorts, acoustic protection, cooling/heating/ventilation equipment, and additional equipment that would be known to one skilled in the art. Similarly, the absence of RFID tags permits operation of those devices could include but is not limited to people, animals, explosive gases, or material that could be damaged by electromagnetic radiation of any sort, or by high acoustic levels, shock, vibration, wind blast, temperature, or other damaging phenomena known to one skilled in the art.

The embodiments described below have the enabling/privilege logic collocated with the interrogator. However, that logic does not necessarily have to be collocated—it could be on the web, implemented as middle-ware, or in any other distributed system as would be known to one skilled in the art. For example, all of the information could be transported via TCP/IP to the logic processor(s).

Examples of protected devices can include, but are not limited to those described as follows:

A vehicle such as but not limited to a truck, ATV (all-terrain vehicle), forklift, motorcycle, automobile, aircraft, locomotive, or earth-moving equipment, boat, ship, hovercraft, outboard motor; or a movable power tool such as but not limited to an air compressor, pump, saw, hydraulic press, crane, construction equipment; or a fixed installation such as a cash register, credit card reader, garage door opener, security system, access gate, movable ramp, factory machinery, heating/ventilation equipment, water/sewer/chemical treatment, power generation/distribution system, inventory management system, warehousing system, waste management system, medical equipment, diagnostic or test equipment, etc.

The following would typically be covered by the first preferred embodiment, with the hidden tag enabling operation;

1) a device which permits access to restricted digital content, such but not limited to a USB (universal serial bus) thumb drive, commercial audio playback device, commercial video playback device, a disk drive that protects its contents or portions thereof, any other device which plays back digital data, a device which decodes or decompresses digital data, or any device which interfaces to such a device via any method using any protocol; or a device that records content, such as an audio or video recorder, including security systems. These could be protected by either the first or second preferred embodiment, where the second embodiment might permit, according to the privilege conveyed, recording, duplicating, or access to only certain material. Additionally, protected (either for payment, business security, or government security) digital content could be downloaded in the presence of a particular card and could only be played back in the presence of that card, regardless of the particular device that the digital content was replayed on, or, if the format or compression has been changed, in that new format or compression;

2) a credit card, or other card, such as an access card, that works only in the presence of the tag. A lost credit card is thus unusable. The credit transaction could be protected by requiring the credit card, the tag associated with the credit card, and a tag associated with the clerk completing the transaction, all to be present. This methodology could be combined with data logging, as described elsewhere, for purposes such as preventing inventory shrinkage;

3) a fixed device which is only to be operated by certain personnel for reasons such as but not limited to expense of operation, expense of misuse including non-monetary expense, safety risk, legal liability, or protection of other valuable property, tangible or intangible. These devices are such as but not limited to factory machinery, medical machinery and devices, dams, power stations, chemical and food processing plants, libraries of all sorts, warehousing and inventory management systems, nuclear power plants, building machinery, lock out/tag out systems, shipboard systems, broadcast equipment, sensitive apparatus for conducting experiments or taking measurements, security and cryptography equipment, computer-numerically controlled machine tools, dispensing machinery, automatic secondary ID for credit card purchase including but not limited to kiosks and gasoline pumps, management of expensive or dangerous inventory, etc. Again, these might be protected by the first preferred embodiment when all users would have the same privilege, and by the second embodiment when different users might have different privileges;

4) a complex system that will only operate when elements of the system are in specific locations, determined either by proximity of the tag to a particular sensor(s) or by a position reporting system, such as but not limited to GPS (Global Positioning System). Examples include but are not limited to systems for protection against explosion, radiation, heat, flame, chemical discharge, high-pressure gas or liquid discharge, discharge or movement of solid material, or other threats to personnel or property; multi-element systems, such as medical systems, or systems that should only be operated when external safety equipment is present, that will not work unless all required devices are present. The complement of tags required could include a complement of operator skills, and allowed complements of number and kind of devices and number and kind of operators; and

5) devices which are maintained, such as ATM machines or vending machines, or high cost of failure machines such as aircraft, medical devices, high energy systems, nuclear systems, satellite control systems, chemical factories, food processing, computer and communications systems, surveillance systems of all kinds, and the like. The tester, maintainer or un/loader of such a device would only be allowed to perform those functions in the presence of the required tag. The operations performed, and any information to be logged, could be enabled the presence of a tag with the required privileges.

In addition to these classes of device, there are other classes of device needing protection from unauthorized use. Examples of protection for these classes include, but are not limited to those described as follows:

1) a motorcycle that will not start when the RFID or emulated RFID tag is not present, providing theft-proofing; or that will have degraded performance and eventually will shut down, providing protection against theft of an already running vehicle;

2) a thumb drive that will not operate in the absence of the RFID or emulated RFID tag, protecting the data from being read or being overwritten if the thumb drive is stolen or misplaced;

3) a thumb drive that is de/encrypted by a code on the RFID or emulated RFID tag, protecting the data from being read or being overwritten if the thumb drive is stolen or misplaced;

4) a computer numerically-controlled (CNC) factory machine that can only be operated while a qualified attendant is present;

5) a blasting system in a mine that will not permit detonation until all tracked personnel and vehicles are clear of the blast zone;

6) a lock, such as a garage door, front door, latch key box, safe, or secured area (secure information, construction site, hazardous work area) lock that will not open/actuate in the absence of the tag; and

7) a cell phone, radio, or communications device that will not operate in the absence of the tag. The tag could enable communication, identify the user, be used for billing and privilege purposes, be used in conjunction with a password or physical key, and be part of en/decryption schemes. The tag could be restricted to specific individual devices by means such as radio finger printing, or information stored on the device to be used, either hard-coded or on a removable memory card, or programmed in for a limited period of operation. Such information could include biometric data and security questions.

In the absence of the correct tags, these devices may have operational characteristics such as, but not limited to those described as follows:

1) failing to start operation;

2) degrading performance when the tag is removed when the device is operating, including failure to operate at all, whether immediately or deferred;

3) working with a different level of performance or privilege or operating mode, either “greater,” “lesser,” or “different” or any combination; and this includes change of performance or privilege if tags appear or disappear while the device is in operation; and

4) broadcasting an alert or an alarm (acoustically, wirelessly, via phone line or on the Internet, or with flashing lights or other such devices, or in any other manner known to one skilled in the art), either conspicuously or silently, when unapproved actuation or operation is attempted without the tag being present.

As described in the Figures included herein, there are a number of levels of complexity for the embodiments described below. Common to all of those levels of complexity are the following:

1) the embodiment provides protection to a protected system based upon the ability to communicate or not with an external device(s);

2) protection includes but is not limited to initial operation of the system; continued operation of the system; and level of performance and/or privilege of the system;

3) the embodiment does not by itself control the protected system—the protected system is primarily controlled as it would be in the absence the embodiment; and

4) the embodiment does not necessarily require any placement of the external device, such as moving it into physical contact with a card reader, putting it under a laser scanner, or swiping a magnetic striped card.

The dimensions of complexity include, but are not necessarily limited to, the following dimensions, and all their permutations and generalizations, as may be clear to one skilled in the art:

1) how many identical tags enable operation of the protected device (enabling tags), either initial operation, continued operation, or both. For example, multiple individuals might be permitted to operate a protected piece of machinery and would have identical tags, whereas a home theater system might have only one tag;

2) whether a combination of separate tags is required to enable operation of the protected device (enabling tags), either initial operation, continued operation, or both. For example, starting and warming up a device might require one kind of privileges but operation of the device might require different privileges;

3) whether there are tags that determine level of performance or privilege of the protected device (privilege tags), and how the system handles the case when multiple tags are detected, including changes in the performance and privilege as tags appear and disappear while the protected device is in operation;

4) whether the system has “master tags” where one tag or a combination of tags will permit operation of numerous protected devices, as would be the case for a repair facility which would need to operate some, many or all devices of a particular make(s) and model(s) or class(es);

5) whether the enabling, privilege, and master tag functionalities must be separate or may be combined;

6) whether multiple devices or subsystems in the protected system are served by the one protected system tag communicator, or just one component or subsystem or one entire system;

7) whether multiple tag communicators are in the protected system, each protecting one or more devices or subsystems;

8) whether a multiplicity of tags are required to provide enabling, privilege, and/or master tag functionalities, analogous to a “two man rule”; and those tags may or may not communicate with each other;

9) whether the enabling tags are read to provide service to one or more “small” areas, such as at an individual control station(s); to one or more “medium” areas, such as a viewing area or a room or a factory area; or one or more “large” areas, such as a building; or a “vicinity,” such as would include a test area for vehicles or a campus or factory; or to any combination of these, including but not limited to multiple retail sites, multiple rooms, or some devices at one site and some devices at one or more other sites;

10) whether the privilege tags are read to provide service to one or more “small” areas, such as at an individual control station(s); to one or more “medium” areas, such as a viewing area or a room or a factory area; or one or more “large” areas, such as a building; or a “vicinity,” such as would include a test area for vehicles or a campus or factory; or to any combination of these, including but not limited to multiple retail sites, multiple rooms, or some devices at one site and some devices at one or more other sites;

11) whether each interrogator is paired with a single (emulated) RFID tag receiver, or whether the interrogator(s) and receiver(s) can be separate units in different locations with different (but overlapping) service areas; whether a tag can be activated by more than one interrogator; whether a tag's reply can be received by more than one receiver, each receiver granting either the same or different enabling and privilege; whether the interrogators and receivers can communicate among themselves to determine tag location and grant enabling and/or privilege based upon location; whether tags communicate among themselves, whether that be one way or bidirectional; and other permutations of communications links as might be known to one skilled in the art;

12) whether the protected system uses presence of the tags alone to determine protection and privilege, or whether protection and privilege are determined in concert with other systems, sensors, and data, including but not limited to tags which report position according to GPS or other position determination systems; data measured by and /or reported by tags; or other data measured by and / or sent to the system by means including but not limited to Internet with its various protocols and encryptions, wireless links of all sorts, including cell phone, Bluetooth, UMA/Wi-Fi, Iridium and other satellite systems; and other systems; serial and parallel links with their various protocols and implementations, infra-red with its various protocols and implementations, ultrasonic or other acoustics, other security systems, etc.;

13) whether encryption is used, including but not limited to verifying the tags by means including but not limited to public / private key encryption; having the tag provide a key to enable en / decoding of protected content, such as but not limited to X.509 (Internet X.509 Public Key Infrastructure Certificate and Certificate Revocation List Profile); and other implementations that would be known to one skilled in the arts of security and encryption;

14) whether other content may be included with the tag communication, including but not limited to who used the system; how much usage is to be charged to their account in ways such as but not limited to duration of usage, when the system was used, resources consumed, privilege levels used, other time-varying billing considerations, and billing rates applicable to this customer, whether monetary or otherwise; to what degree this usage satisfies recent experience requirements or training requirements or applies to time on duty or similar limitations;

15) whether this session is stored, either on conventional electronic storage such as a computer disk, flash memory, on paper, or printed on paper;

16) whether the system requires only one kind of tags, such as RFID or emulated RFID, or whether multiple kinds of tags, such as RFID or emulated RFID and cell phone, are required;

17) whether the tag system uses only one set of tags, or whether it “speaks” multiple kinds of tags, such as UPC (Universal Product Code), DOD (Department of Defense), and others. Those multiple tags may be used either one at a time or in concert, such as requiring the correct UPC tag and DOD tag for allowing privilege.

18) whether a tag has single functions, such as a garage door tag, or whether it has multiple functions, such as household locks, digital content privileges, credit card authentications, customer ID at one or more stores, power tool operating privileges, and possibly multiple privileges from other domains, such as work, volunteer organizations, shared or rented equipment, additional households, etc. A proposed name for this kind of single tag with multiple access and privileges is “Uni-Tag”; and

19) combining tag information with other information, including passwords, biometric data including voice recognition, knowledgeable or skilled manipulation of devices to authenticate identity for access and privileges; or storing that other information on the tag, including passwords, biometric data including voice recognition, and expected results of knowledgeable or skilled manipulation of devices to authenticate identity for access and privileges.

Devices that can be dis/allowed, permissioned, switched on or off, through use of the present invention, include, but are not limited to form factors such as, but not limited to;

1) electronic devices, such as, but not limited to computers, sound systems, security systems, modems, servers, routers, cell phones, set-top boxes, televisions, GPS receivers, radio and communications equipment of all sorts, ATM (automatic teller machines) machines, landline phones, VoIP (Voice over Internet Protocol) wireless phones, VoIP landline phones, digital cameras, electrical outlets, interface devices that plug into electrical outlets, iPODs, Rios, etc., DVD (Digital Video Disk)/Blueray players/recorders, RFID readers, computer mouse, PDAs (personal digital assistants), computers, laptops, notebooks, external hard drives, CD (compact disk) burners, DVD burners, gaming equipment—X Box, Nintendo, etc., camcorders, cameras of all sorts, movie cameras of all sorts, microscopes, copiers, fax machines, printers, cash registers, bar code readers, LCD and other projectors, PBXs (private branch exchanges), home networking devices, entertainment centers, personal video recorders of all sorts, sensors, clocks, audio speakers, servers, amplifiers, monitors, video displays, smart cards, databus controllers, tape recorders of all kinds and formats, USB thumb drives, flash memory cards of all sorts, various kinds of memory cards, commercial audio playback device, commercial video playback device, a disk drive that protects its contents or portions thereof, any other device which plays back digital data, a device which decodes or decompresses digital data, or any device which interfaces to such a device via any method using any protocol, lighting control systems including internal, external, theater, home, event, streets, parking, and other lighting systems; etc.;

2) vehicles such as, but not limited to a truck, ATV, forklift, motorcycle, boat, ship, automobile, aircraft, hovercraft, locomotive, or earth-moving equipment; movable power tools, such as, but not limited to medical device, air compressor, pump, saw, hydraulic press, crane, construction equipment;

3) fixed installations, such as, but not limited to, a cash register, credit card reader, medical devices, garage door opener, home or industrial security system, factory machinery, truck or rail car loading and unloading, warehousing equipment, heating/ventilation equipment, water/sewer/chemical/food/animal treatment or processing, waste management systems, medical machinery and devices, dams, power generation and distribution stations, nuclear power plants, building machinery, lock out / tag out systems, shipboard systems, broadcast equipment, sensitive apparatus for conducting experiments or taking measurements, security and cryptography equipment, computer-numerically controlled machine tools, dispensing machinery, kiosks, gasoline pumps, vending machines, etc.;

4) credit card or other card, such as, but not limited to an access card, that works only in the presence of the tag; safety system, both portable and fixed, for protection against explosion, radiation, heat, flame, chemical discharge, high-pressure gas or liquid discharge, discharge or movement of solid material, bio-hazard control, or other threats to personnel or property; high cost of failure machines, such as, but not limited to, aircraft, medical devices, high energy systems, nuclear systems, inventory control and management, systems operations control centers, web servers, computer centers, communications systems, traffic management systems, continuously operated processes of all sorts, and the like, and any specialized equipment used to maintain, service, test, and/or monitor such machines; and

5) Systems with high cost of misuse, such as financial systems, systems storing classified information or other sensitive information, personnel and medical records, or any other systems containing information which could lead to litigation, financial loss, loss of reputation or privacy, loss of trade secrets, or similar loss.

According to one aspect of the present invention, a method of emulating a physical RFID tag is provided. The method includes storing in a machine readable memory an RFID tag encoding, communicating the RFID tag encoding to a system, and using the RFID tag encoding at the system to emulate the physical RFID tag and perform a function without emulating an RFID transponder signal.

According to another aspect of the present invention, a method of using an RFID tag encoding to provide privilege is provided. The method includes communicating the RFID tag encoding to a system and using the RFID tag encoding at the system to establish a privilege associated with the system.

According to another aspect of the present invention, an apparatus for emulating a physical RFID tag is provided. The apparatus includes a machine readable memory configured to store an RFID tag encoding, and a communications device operatively connected to the machine readable memory, the communications device configured to communicate the RFID tag encoding to a system such that the apparatus provides for emulating the physical RFID tag without emulating an RFID transponder signal.

### BRIEF DESCRIPTION OF THE DRAWINGS

FIG. 1 is an embodiment of the present invention.

FIG. 2 is an alternative embodiment of the present invention.

FIG. 3 is an alternative embodiment of the present invention.

FIG. 4 is an alternative embodiment of the present invention.

FIG. 5 is an alternative embodiment of the present invention.

FIG. 6 is an alternative embodiment of the present invention.

FIG. 7 is an alternative embodiment of the present invention.

FIG. 8 is an alternative embodiment of the present invention.

### DETAILED DESCRIPTION OF THE PREFERRED EMBODIMENTS

The present invention describes systems, methods, and apparatuses for providing electronic security to devices to avoid high-value loss, whether that loss be incurred by theft of the device itself; by costs due to information theft from or via that device; by cost due to operator impersonation and device misuse; by regulatory penalty arising from non-compliance in the device's operation; or by restitution arising from device misuse by unauthorized operators.

The present invention uses “normal RFID”, and/or “emulated RFID”.

Normal Radio-Frequency Identification (RFID) is the use of an object (typically referred to as an RFID tag) applied to or incorporated into a product, animal, or person for the purpose of identification and tracking using radio waves. Some tags can be read from several meters away up to far beyond the line of sight of the reader.

Radio-frequency identification comprises interrogators (also known as readers), and tags (also known as labels).

Most RFID tags contain at least two parts. One is an integrated circuit for storing and processing information, modulating and demodulating a radio-frequency (RF) signal, and other specialized functions. The second is an antenna for receiving and transmitting the signal.

There are generally three types of RFID tags: active RFID tags, which contain a battery and can transmit signals autonomously, passive RFID tags, which have no battery and require an external source to provoke signal transmission, and battery assisted passive (BAP) RFID tags, which require an external source to wake up but have significant higher forward link capability providing greater range.

There are a variety of groups defining standards and regulating the use of RFID, including: International Organization for Standardization (ISO), International Electrotechnical Commission (IEC), ASTM International, DASH7 Alliance, EPCglobal.

RFID has many applications; for example, it is used in enterprise supply chain management to improve the efficiency of inventory tracking and management.

Barcode and RFID technologies can both use the EPCglobal standards for identification. In addition, the EPCglobal Gen 2 standard defines RFID reader hardware and tag standards for interoperability. In addition to the ubiquitous nature of barcodes and RFID tags that conform to the EPCglobal standard, tags can be created that include a free-form customizable area that a vendor can use for purposes other than product or company identification, such as information and data used in the conjunction with the present invention.

Emulated Radio-Frequency Identification (RFID) is novel to the present invention, and is the use of an object (typically referred to as an emulated RFID tag) applied to or incorporated into a product, animal, or person for the purpose of identification and tracking using radio waves. Some emulated tags can be read from several meters away up to far beyond the line of sight of the reader.

Emulated Radio-Frequency Identification comprises emulated interrogators (also known as emulated readers), and emulated tags (also known as emulated labels). Emulated interrogators can be deployed in the form of a wireless access point, such as, but not limited to, a Wi-Fi, My-Fi, cell tower, router, switch, hub, computer, laptop, net book, notebook, tablet, cell phone, pager, wireless landline phone, femto-cell, etc.

Emulated RFID tags contain at least two parts. One is an integrated circuit for storing and processing information, modulating and demodulating a radio-frequency (RF) signal, other electromagnetic signal, or acoustical signal, and other specialized functions. The emulated RFID signal can be a technology such as, but not limited to, Bluetooth, Wi-Fi, My-Fi, TDMA, CDMA, UWB, etc. The second is an appropriate antenna or other interface device for receiving and transmitting the signal.

There is generally one type of emulated RFID tag: active emulated RFID tags, which contain a battery and can transmit signals autonomously,

There are a variety of groups defining standards and regulating the use of RFID, which can be applied to emulated RFID, including: International Organization for Standardization (ISO), International Electrotechnical Commission (IEC), ASTM International, DASH7 Alliance, EPCglobal. (Refer to Regulation and standardization below.)

Emulated RFID has many applications; for example, it is used in enterprise supply chain management to improve the efficiency of inventory tracking and management.

Emulated barcode and emulated RFID technologies can both use the EPCglobal standards for identification. In addition, the EPCglobal Gen 2 standard defines RFID reader hardware and tag standards for interoperability. In addition to the ubiquitous nature of barcodes and RFID tags that conform to the EPCglobal standard, tags can be created that include a free-form customizable area that a vendor can use for purposes other than product or company identification, such as information and data used in the conjunction with the present invention

One embodiment described herein is by using EPC (Electronic Product Code) global RFID tags, where a device(s) only works at all, or at a given level of privilege, when an appropriate RFID tag(s) is detected. It is the detection of that RFID tag, and possibly information contained on that tag, that provides enabling and/or privilege.

The second way of implementing such protection is when the function of the RFID tag is emulated, i.e., the EPC global tag functionality is implemented over a communications link other than “normal” RFID, and/or using tags other than “normal” RFID tags. One advantage is that all of the EPC Global protocols, formats, and algorithms can be used unchanged. Another advantage is that greater flexibility in communications is available, such as operation over a distance or secure communications.

It should be noted that privilege tags do not necessarily build in layers of privilege. For example, a car might have these kinds of privilege: full privilege;

reduced horsepower and top speed for younger driver; full horsepower but reduced driving distance and GPS tracking turned on for a dealer to demonstrate a new car; full horsepower but reduced driving distance and GPS tracking turned on for a mechanic to road test a car.

It should also be noted, there is no implication intended in the specification that each kind of privilege is a superset of the “lower” privilege. Kinds of privilege granted may include cases where each kind of privilege is a superset of “lower” privilege as well as cases in which the kinds of privileges are not sub- and supersets of each other.

There are innumerable permutations of such tags, links, systems, components, networks, and outboard devices as would be known to one skilled in the art.

There are a host of embodiments that are covered by this invention, as well as like kind embodiments that will be known to those skilled in the art. Representative embodiments are described in the Figures, and one skilled in the art would readily comprehend the variety of permutations.

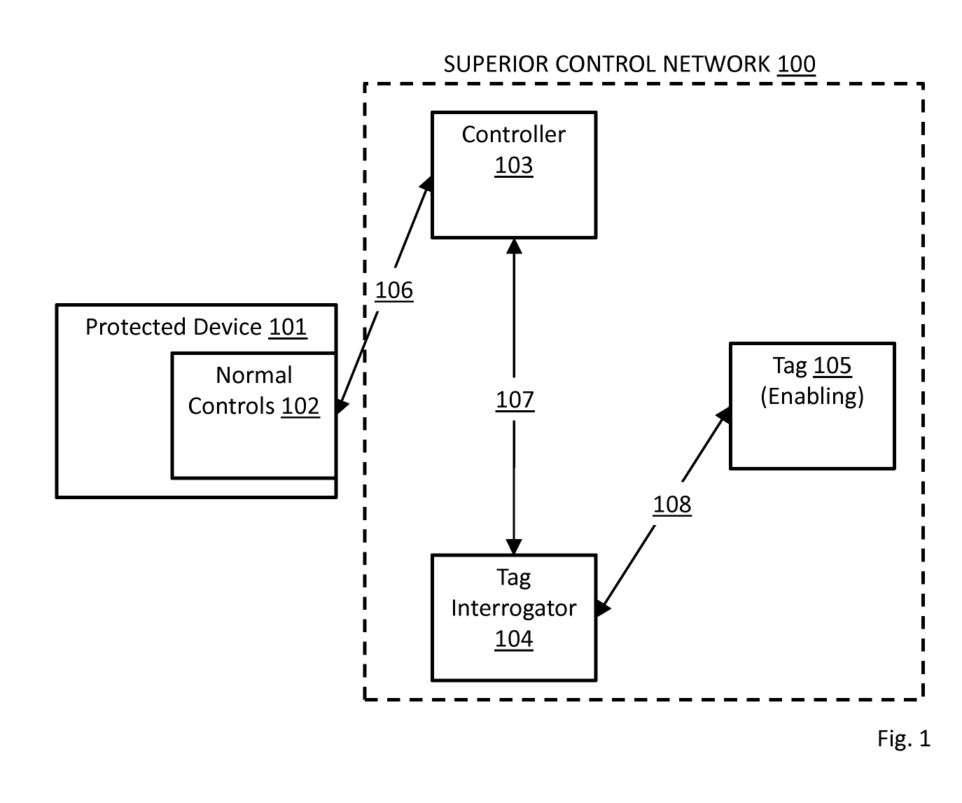

FIG. 1 illustrates the simplest embodiment of the invention, in which the host has an active RFID or emulated RFID interrogator which looks for an RFID tag or emulated RFID tag, normally hidden in proximity to the protected device, to permit operation. In this system, there can be one or multiple RFID and/or emulated RFID tags with identical functionality, analogous to multiple identical keys to a single lock.

This embodiment can be operated in either of two modes, or both. The protected device in this embodiment may include devices such as, but not limited to a vehicle such but not limited to a truck, ATV, forklift, motorcycle, boat, airplane, or automobile; or a movable power tool such but not limited to medical device, air compressor, pump, saw, computer-numerically controlled machine tools, dispensing machinery; or a system such as but not limited to a broadcast system, home theater system, computer, printer, etc. Mode 1 is “permits starting,” and could be applied to a device such as but not limited to those just listed. In this embodiment, as part of the turn on sequence, after actuation of a conventional key or on/off switch, the normal controls 102 communicate with the superior control network in order to search for an RFID tag, or emulated RFID tag. If the tag is present, the superior network's controller permits the protected device to start, or to turn on. If the RFID or emulated RFID tag is absent, the device is not permitted to turn on. As an option, a warning message or a theft detected message could be enabled, such message being visual, aural, broadcast in one or more wireless media, or any combination of these, as would be well-known to one skilled in the art.

The second mode, Mode 2, of this embodiment is “continued operation.” In this embodiment, continuous operation would be applicable to an automobile, as an example. If the RFID tag, or emulated RFID tag, is removed from the immediate vicinity of the vehicle once the vehicle is operating, continued operation is compromised. This compromise could be immediate shutdown; keeping the vehicle's transmission in Park or Neutral, allowing passenger comfort and entertainment services to continue while the operator leaves the vehicle momentarily; or delayed shutdown, such as would permit a perpetrator to distance himself from the site of the crime and/or the victim before the vehicle shut down. There are a variety of known techniques that this mode would permit.

Protected device 101 is any device, or machine that can be configured to work with superior control network of the present invention.

Normal controls 102 are the normal controls that are used to operate a device, or machine, but which are also configurable to work with the superior control network of the present invention.

The superior control network 100 of the present invention consists of the following items:

Controller 103, which is the interface point of the present invention with normal controls 102 and protected device 101. Controller 103 is designed to communicate with normal controls 102 via communication channel 106, and tag interrogator 104 via communication channel 107.

Controller 103 is the interface point of the present invention with protected device 101. The enabling mechanism of protected device 101 can be accomplished through normal controls 102, as shown, or the enabling can be accomplished by having communications channel 106 talk to a part of protected device 101 not manipulated by normal controls 102, or by any combination of these, as would be known to one skilled in the art. For example, a motorized vehicle might have normal engine controls but the enabling sent from controller 103 might control a separate device, such as a fuel shutoff, which is not normally managed by normal controls 102. On the other hand, a computer-controlled device would likely have communications channel 106 communicate with the computer that interfaces with normal controls 102. This distinction is implicitly contained in the figures.

In FIG. 1, normal controls 102 is shown as one logical entity. This includes the case in which normal controls 102 are implemented as one or more separate entities, whether that separation be logical or physical.

Communication channel 106 is the means by which controller 103 communicates with normal controls 102 Communication channel 107 is the means by which controller 103 communicates with tag interrogator 104.

Communication channel 108 is the means by which tag interrogator 104 communicates with tag 105.

Tag interrogator 104 is capable of receiving instructions from controller 103, and communicating with tag 105, if it is within communication range.

Tag 105 is a device that is capable of communicating with tag interrogator 104, if it is within communication range via communication channel 108. Tag 105 is programmable to include data such as, but not limited to, a tag identification number, a user identification number, and other data that can be used by the superior control network 100 to control protected device 101 via normal controls 102. In FIG. 1, tag 105 is a tag that is configured as an enabling tag. An enabling tag will allow the unrestricted access and use of any protected device 101

A real-world implementation example of FIG. 1 using equipment modified to interface with non-emulated RFID includes equipment such as, but not limited the following:

1) Protected device 101 is a TV set

2) Normal controls 102 are the integrated controls for the TV set

3) Controller 103 is a TV set infra-red, wireless remote

4) Tag interrogator 104 is an RFID interrogator

5) Tag 105 is an RFID tag providing enablement

6) 106, 107, and 108 are communication channels

A child wishes to turn on the TV set. The child picks-up the wireless remote, and attempts to turn on the TV set. The wireless remote (controller 103) communicates wirelessly with tag interrogator 104 via Bluetooth, and issues a request for the tag interrogator 104 to verify the close proximity presence of RFID tag (tag 105). If the tag interrogator 104 detects the close proximity of the RFID tag (tag 105) using a standard FCC unlicensed channel suitable for use with RFID, it sends a Bluetooth wireless message to the television that the RFID tag (tag 105) is within range, and the wireless message includes relevant data stored on the RFID tag (105), such as a tag ID, a user ID, and any other relevant data, which in essence grants permission for the child to turn on the TV set (protected device 101). Alternatively, the tag interrogator and/or tag receiver could be incorporated into the wireless remote. This describes privilege . . . but the rest of the text talks enabling only

In general, if tag 105 is moved out of readable proximity of the tag interrogator 104, the controller 103 may immediately be programmed to shut down the protected device 101; or pause the protected device 101: or cause protected device to park: or cause the protected device 101 to safeguard sensitive data or material, or some similar action. Furthermore, controller 103 may cause the desired action to take place after some additional conditions are met, such as after a presumably stolen vehicle has driven a predetermined distance from where the presumed theft took place, or after an operator has had a chance to remedy the missing tag 105 via appropriate action. At any time interrogator senses the loss of communication with tag 105, the controller 103 may communicate with the protected device 101 via communication channel 107 to create an alarm. That alarm may be aural, visual, internet, cell phone, wireless, or any combination; and that alarm may be silent or conspicuous.

The techniques of FIG. 1 and the various Figures described below in the present invention can be implemented using EPC Global standards, or with custom hardware and protocols, or with emulated RFID technology, which will be described in detail later in the present invention.

A real-world implementation example of FIG. 1 using equipment modified to interface with emulated RFID includes equipment such as, but not limited the following:

1) Protected device 101 is a TV set

2) Normal controls 102 are the integrated controls for the TV set

3) Controller 103 is a TV set infra-red, wireless remote

4) Tag interrogator 104 is an emulated RFID interrogator (Wi-Fi router connected to a control file on a server, laptop, PC, etc.)

5) Tag 105 is an emulated RFID tag (cell phone enabled with a Wi-Fi communication capability)

6) 106, 107, and 108 are communication channels

A child wishes to turn on the TV set. The child picks-up the wireless remote, and attempts to turn on the TV set. The enabled wireless remote (controller 103) communicates wireless with tag interrogator 104 via 802.11 wireless, which communicates with a remote server that contains the file with enablement instructions. Emulated tag interrogator receives enablement instructions from the remote server, and issues a request for the emulated tag interrogator 104 to verify the close proximity presence of emulated RFID tag (a cell phone enabled with Wi-Fi communication capability). If the emulated tag interrogator 104 detects the close proximity of the emulated RFID tag (tag 105) using Wi-Fi, it sends a wireless message to the wireless remote that the RFID tag (cell phone) is within range, and the wireless message includes relevant data stored on the RFID tag (cell phone), such as a emulated tag ID, a user ID, and any other relevant data, which in essence grants permission for the child to turn on the TV set (protected device 101). Alternatively, communications channel 106 could communicate with the normal controls 102 on the television itself, instead of the wireless remote.

In general, if emulated tag 105 is moved out of readable proximity of the emulated tag interrogator 104, the controller 103 could immediately be programmed to shut down the protected device 101; or pause the protected device 101: or cause protected device to park: or cause the protected device 101 to safeguard sensitive data or material, or some similar action. Furthermore, controller 103 could cause the desired action to take place after some additional conditions are met, such as after a presumably stolen vehicle has driven a predetermined distance from where the presumed theft took place, or after an operator has had a chance to remedy the missing emulated tag 105 (cell phone) via appropriate action. At any time interrogator senses the loss of communication with emulated tag 105 (cell phone), the controller 103 may communicate with the protected device 101 via communication channel 107 to create an alarm. That alarm may be aural, visual, internet, cell phone, wireless, or any combination; and that alarm may be silent or conspicuous.

The techniques of FIG. 1 and the various Figures described below in the present invention can be implemented using EPC Global standards, or with custom hardware and protocols, or with emulated RFID technology, which will be described in detail later in the present invention.

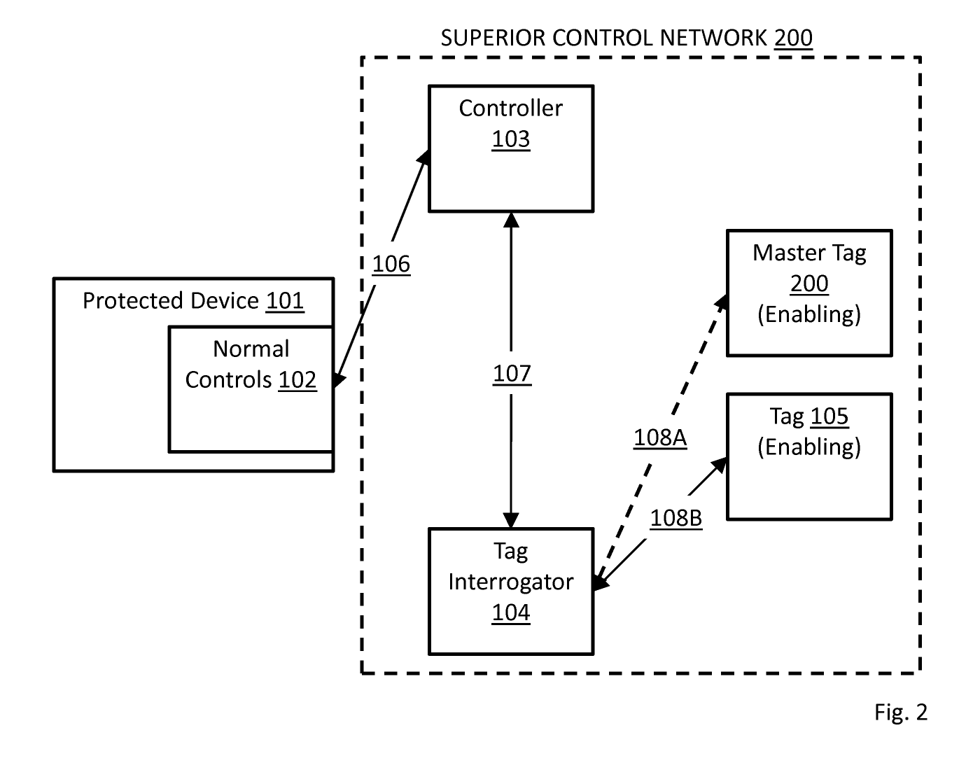

FIG. 2 extends the functionality of FIG. 1 by having the superior control network 200 recognize both 1) tags unique to that protected device, and also 2) master tags that enable a set of protected devices. In this system, there can be one or multiple RFID and/or emulated RFID tags and/or one or multiple master tags with identical functionality, analogous to multiple identical keys to a single lock.

For example, a repair shop might have a master tag that would enable all devices of a particular type or class to operate within that shop

Protected device 101 is any device, or machine that can be configured to work with superior control network of the present invention.

Normal controls 102 are the normal controls that are used to operate a device, or machine, but which are also configurable to work with the superior control network of the present invention.

The superior control network 200 of the present invention consists of the following items:

Controller 103, which is the interface point of the present invention with normal controls 102 and protected device 101. Controller 103 is designed to communicate with normal controls 102 via communication channel 106, and tag interrogator 104 via communication channel

Communication channel 106 is the means by which controller 103 communicates with normal controls 102. Communication channel 107 is the means by which controller 103 communicates with tag interrogator 104.

Communication channels 108A, 108B are the means by which tag interrogator 104 communicates with master tag 200 and tag 105 respectively.

Tag interrogator 104 is capable of receiving instructions from controller 103, and communicating with tag 200 and/or 105, if within communication range.

Tag 105 is a device that is capable of communicating with tag interrogator 104, if it is within communication range. Tag 105 is programmable to include data such as, but not limited to, a tag identification number, a user identification number, and other data that can be used by the superior control network 200 to control protected device 101 via normal controls 102. In FIG. 2, tag 105 is a tag that is configured as an enabling tag. An enabling tag will allow the unrestricted access and use of any protected device 101.

Master tag 200 is a device that is capable of communicating with tag interrogator 104, if it is within communication range. Tag 200 is programmable to include data such as, but not limited to, a tag identification number, a user identification number, and other data that can be used by the superior control network 100 to control protected device 101 via normal controls 102. In FIG. 2, master tag 200 is a tag that is configured as an enabling tag. An enabling tag will allow the unrestricted access and use of any protected device 101

Whereas in FIG. 1, the protected device would only be enabled by the unique information contained in tag 105, in FIG. 2, a protected device can be enabled either by tag 105 or by master tag 200. It would be apparent to one skilled in the art, master tag 200 would normally be used by personnel in a repair shop, as an example,

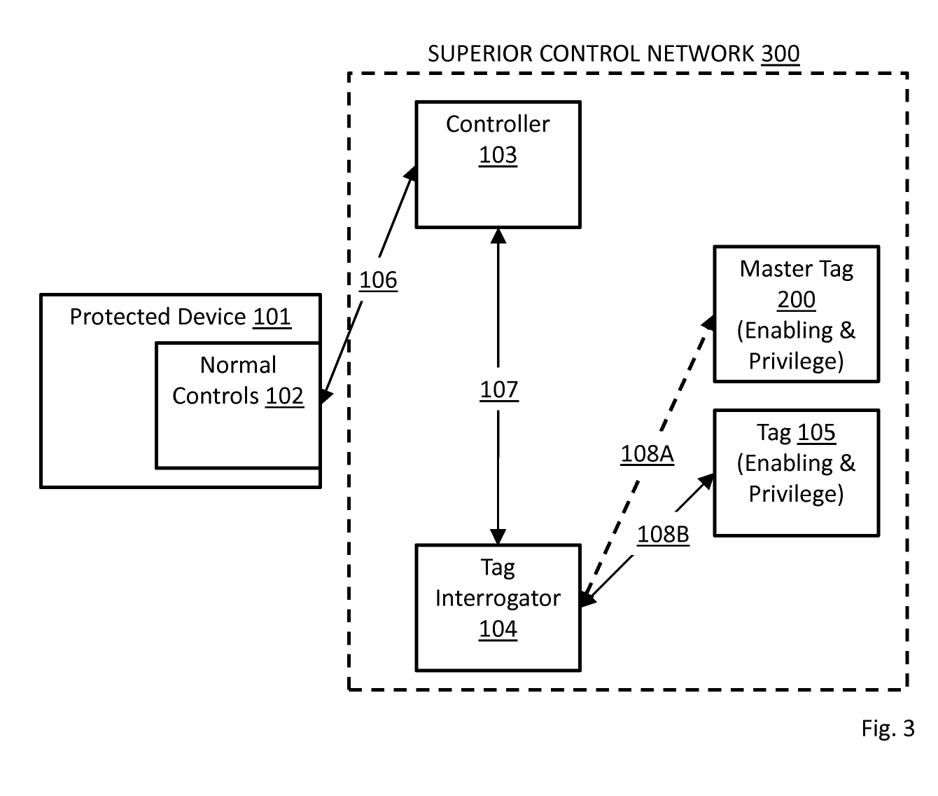

FIG. 3 illustrates an alternative embodiment of the invention in which the basic simple protection with RFID tags that offer both enablement and privilege, and an optional master tag. FIG. 3 illustrates an embodiment in which system operation is determined by a function whose domain is one or more tags, both individual and master. Each tag may be enabling, privilege, or a combination. For example, in accessing classified documents, the tags present in a room may allow access to secure information if two cleared individuals are present (enforcing the two-man rule), but access may be denied if someone is in the room with inadequate clearance. In operating a piece of machinery, that machinery might be programmed to provide the capabilities allowed to the user with the highest privilege. Or, in operating a complex suite of machinery with multiple qualifications required, the machinery might operate only when all qualifications are satisfied by those present. Those required qualifications need not be static, but could be determined by time of day, day of the week, weather, or other operational considerations.

Protected device 101 is any device, or machine that can be configured to work with superior control network of the present invention.

Normal controls 102 are the normal controls that are used to operate a device, or machine, but which are also configurable to work with the superior control network of the present invention.

The superior control network 300 of the present invention consists of the following items:

Controller 103, which is the interface point of the present invention with normal controls 102 and protected device 101. Controller 103 is designed to communicate with normal controls 102, and tag interrogator 104.

Communication channel 106 is the means by which controller 103 communicates with normal controls 102.

Communication channel 107 is the means by which controller 103 communicates with tag interrogator 104.

Communication channels 108A, 108B are the means by which tag interrogator 104 communicates with master tag 200 and tag 105 respectively.

Tag interrogator 104 is capable of receiving instructions from controller 103, and communicating with tags 200 and/or 105, if within communication range.

Tag 105 is a device that is capable of communicating with tag interrogator 104, if it is within communication range. Tag 105 is programmable to include data such as, but not limited to, a tag identification number, a user identification number, and other data that can be used by the superior control network 300 to control protected device 101 via normal controls 102. In FIG. 3, tag 105 is a tag that is configured as an enabling and privilege tag. An enabling tag will allow the unrestricted access and use of any protected device 101. A tag that includes privilege programmed data will restrict the use and operation of any protected device 101.

Master tag 200 is a device that is capable of communicating with tag interrogator 104, if it is within communication range. Tag 200 is programmable to include data such as, but not limited to, a tag identification number, a user identification number, and other data that can be used by the superior control network 100 to control protected device 101 via normal controls 102. In FIG. 3, master tag 200 is a tag that is configured as an enabling and privilege tag. A tag that includes privilege programmed data will restrict the use and operation of any protected device 101.

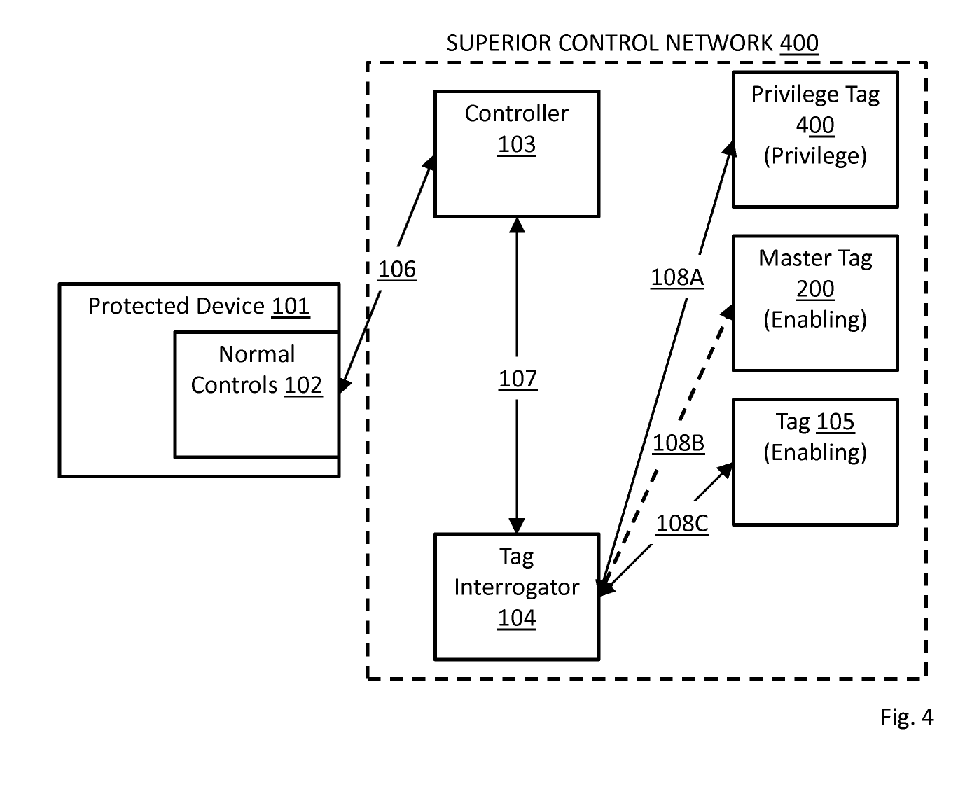

FIG. 4 is an alternative embodiment of the present invention.

Protected device 101 is any device, or machine that can be configured to work with superior control network of the present invention.

Normal controls 102 are the normal controls that are used to operate a device, or machine, but which are also configurable to work with the superior control network of the present invention.

The superior control network 400 of the present invention consists of the following items:

Controller 103, which is the interface point of the present invention with normal controls 102 and protected device 101. Controller 103 is designed to communicate with normal controls 102, and tag interrogator 104.

Communication channel 106 is the means by which controller 103 communicates with normal controls 102.

Communication channel 107 is the means by which controller 103 communicates with tag interrogator 104.

Communication channels 108A, 108B, and 108C are the means by which tag interrogator 104 communicates with privilege tag 400, master tag 200 and enabling tag 105 respectively.

Tag interrogator 104 is capable of receiving instructions from controller 103, and communicating with tag 105, if it is within communication range.

Tag 105 is a device that is capable of communicating with tag interrogator 104, if it is within communication range. Tag 105 is programmable to include data such as, but not limited to, a tag identification number, a user identification number, and other data that can be used by the superior control network 100 to control protected device 101 via normal controls 102. In FIG. 4, tag 105 is a tag that is configured as an enabling tag. An enabling tag will allow the unrestricted access and use of any protected device 101.

Master tag 200 is a device that is capable of communicating with tag interrogator 104, if it is within communication range. Tag 200 is programmable to include data such as, but not limited to, a tag identification number, a user identification number, and other data that can be used by the superior control network 100 to control protected device 101 via normal controls 102. In FIG. 4, master tag 200 is a tag that is configured as an enabling tag. An enabling tag will allow the unrestricted access and use of any protected device 101.

Privilege tag 400 is a device that is capable of communicating with tag interrogator 104, if it is within communication range. Privilege tag 400 is programmable to include data such as, but not limited to, a tag identification number, a user identification number, and other data that can be used by the superior control network 400 to control use of the protected device 101 via normal controls 102. In FIG. 4, tag 200 is a tag that is configured as a privilege tag. Any type of tag in the present invention that includes privilege data will restrict use of any protected device 101.

When tag 105 and privilege tag 400 are detected by tag interrogator 104, controller 103 can be actuated, as previously described in FIGS. 1 through 3. In this embodiment, however, tag 105 provides protection against unauthorized removal or usage, and separate privilege tag 400 allows for different privileges for use of protected device 101 to be programmed for each individual user.

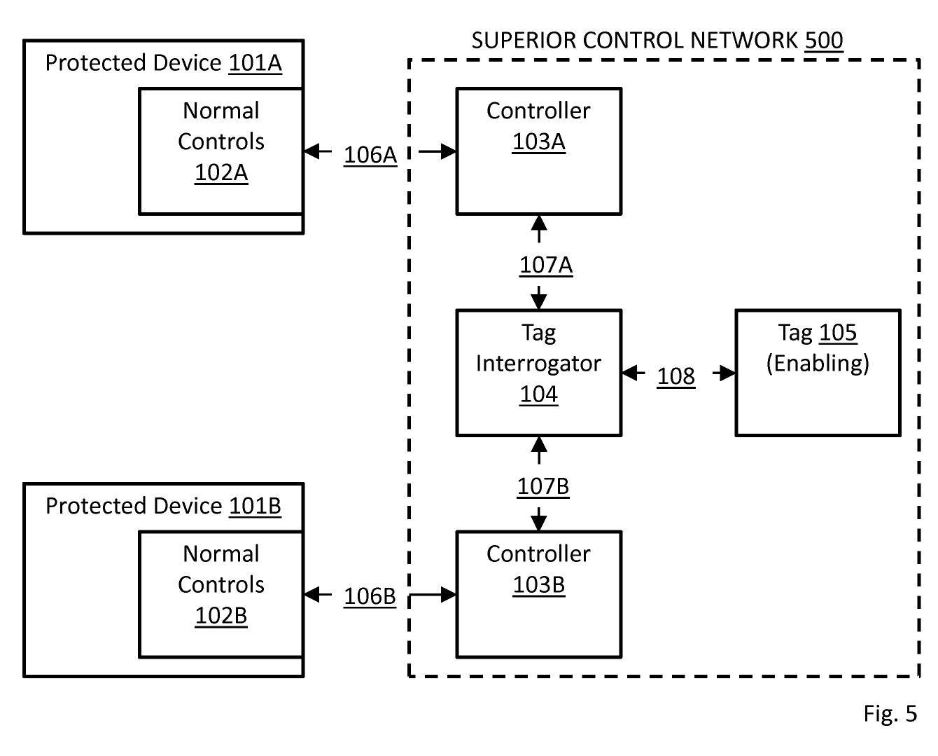

FIG. 5 is an illustration of alternative embodiment of the present invention in programmability permitted by enabling tags.

Protected device 101A, 101B are any device, or machine that can be configured to work with superior control network of the present invention.

Normal controls 102A, 102B are the normal controls that are used to operate a device, or machine, but which are also configurable to work with the superior control network of the present invention.

The superior control network 500 of the present invention consists of the following items:

Controller 103A, which is the interface point of the present invention with normal controls 102A and protected device 101A. Controller 103A is designed to communicate with normal controls 102A, and tag interrogator 104.

Communication channel 106A is the means by which controller 103A communicates with normal controls 102A.

Controller 103B, which is the interface point of the present invention with normal controls 102B and protected device 101B. Controller 103B is designed to communicate with normal controls 102B, and tag interrogator 104.

Communication channel 106B is the means by which controller 103B communicates with normal controls 102B.

Communication channel 107A is the means by which controller 103A communicates with tag interrogator 104.

Communication channel 107B is the means by which controller 103B communicates with tag interrogator 104.

Communication channel 108 is the means by which tag interrogator 104 communicates with tag 105.

Tag interrogator 104 is capable of receiving instructions from controller 103A and/or 103B, and communicating with tag 105, if within communication range.

Tag 105 is a device that is capable of communicating with tag interrogator 104, if it is within communication range. Tag 105 is programmable to include data such as, but not limited to, a tag identification number, a user identification number, and other data that can be used by the superior control network 500 to control protected device 101A and/or 101B via normal controls 102A and/or 102B respectively. In FIG. 5, tag 105 is a tag that is configured as an enabling tag. An enabling tag will allow the unrestricted access and use of any protected device 101A, 101B.

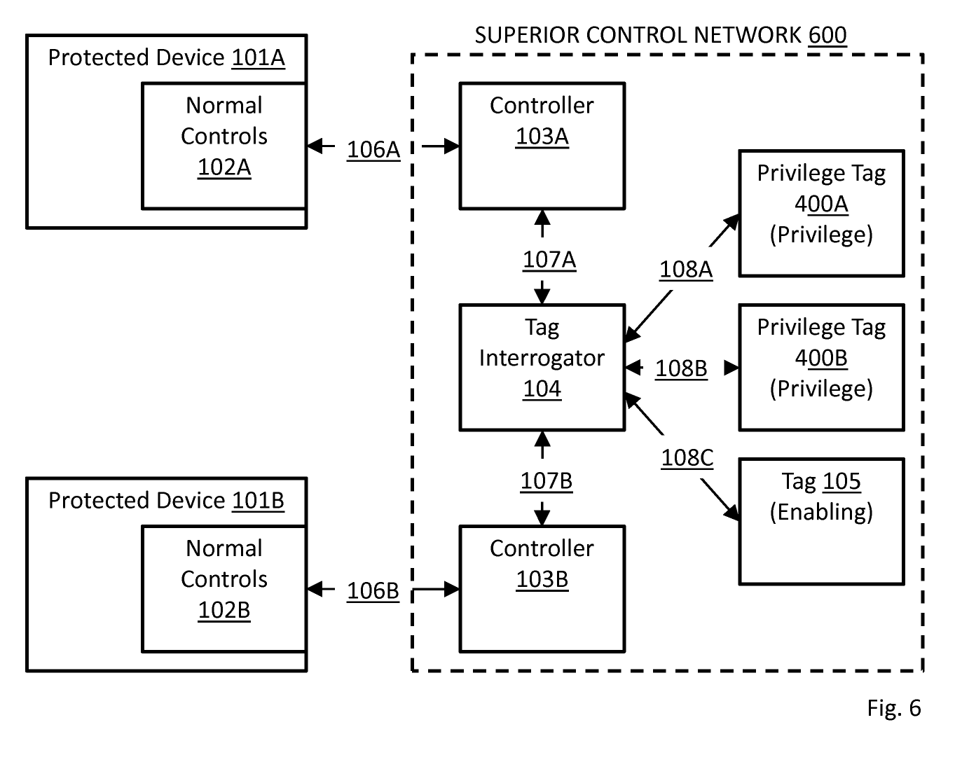

FIG. 6 is an illustration of alternative embodiment of the present invention.

Protected device 101A, 101B is any device, or machine that can be configured to work with superior control network of the present invention.

Normal controls 102A, 102B are the normal controls that are used to operate a device, or machine, but which are also configurable to work with the superior control network of the present invention.

The superior control network 600 of the present invention consists of the following items:

Controller 103A, which is the interface point of the present invention with normal controls 102A and protected device 101A. Controller 103A is designed to communicate with normal controls 102A, and tag interrogator 104.

Communication channel 106A is the means by which controller 103A communicates with normal controls 102A.

Controller 103B, which is the interface point of the present invention with normal controls 102B and protected device 101B. Controller 103B is designed to communicate with normal controls 102B, and tag interrogator 104.

Communication channel 106B is the means by which controller 103B communicates with normal controls 102B.

Communication channel 107A is the means by which controller 103A communicates with tag interrogator 104.

Communication channel 107B is the means by which controller 103B communicates with tag interrogator 104.

Communication channels 108A, 108B, 108C is the means by which tag interrogator 104 communicates with privilege tag 400A, 400B, and/or tag 105.

Tag interrogator 104 is capable of receiving instructions from controller 103A and/or 103B, and communicating with tag 105, if within communication range.

Tag 105 is a device that is capable of communicating with tag interrogator 104, if it is within communication range. Tag 105 is programmable to include data such as, but not limited to, a tag identification number, a user identification number, and other data that can be used by the superior control network 100 to control protected device 101A and/or 101B via normal controls 102A and/or 102B respectively.

In FIG. 6, tag 105 is a tag that is configured as an enabling tag. An enabling tag will allow the unrestricted access and use of any protected device 101A and/or 101B.

Privilege tag 400A, 400B are devices that are capable of communicating with tag interrogator 104, if it is within communication range. Privilege tag 400A, 400B are programmable to include data such as, but not limited to, a tag identification number, a user identification number, and other data that can be used by the superior control network 600 to control use of the protected device 101 via normal controls 102.

When tag 105 and/or privilege tag 400A and/or 400B are detected by tag interrogator 104, controller 103A and/or 103B can be actuated, as previously described. In this embodiment, however, tag 105 provides protection against unauthorized removal or usage, and separate privilege tag 400A and/or 400B allows for different privileges for use of protected device 101A and/or 101B to be programmed for each individual user, or for combinations of user privileges.

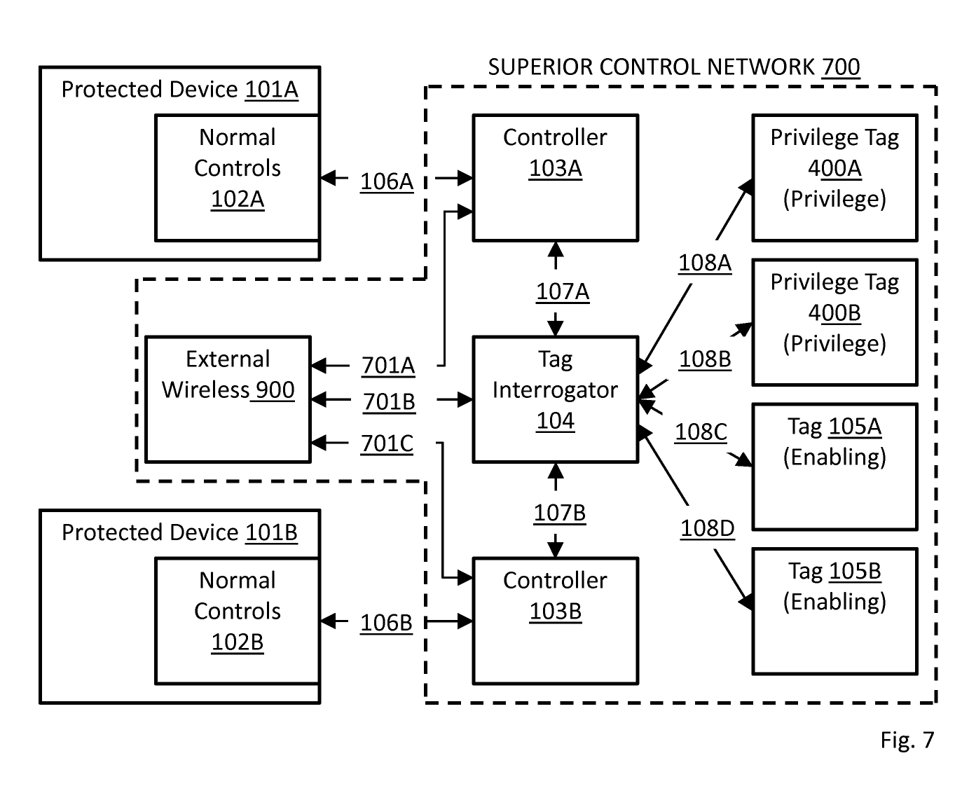

FIG. 7 is an illustration of alternative embodiment of the present invention.

Protected device 101A, 101B is any device, or machine that can be configured to work with superior control network of the present invention.

Normal controls 102A, 102B are the normal controls that are used to operate a device, or machine, but which are also configurable to work with the superior control network of the present invention.

The superior control network 700 of the present invention consists of the following items:

Controller 103A, which is the interface point of the present invention with normal controls 102A and protected device 101A. Controller 103A is designed to communicate with normal controls 102A, and tag interrogator 104.

Communication channel 106A is the means by which controller 103A communicates with normal controls 102A.

Controller 103B, which is the interface point of the present invention with normal controls 102B and protected device 101B. Controller 103B is designed to communicate with normal controls 102B, and tag interrogator 104.

Communication channel 106B is the means by which controller 103B communicates with normal controls 102B.

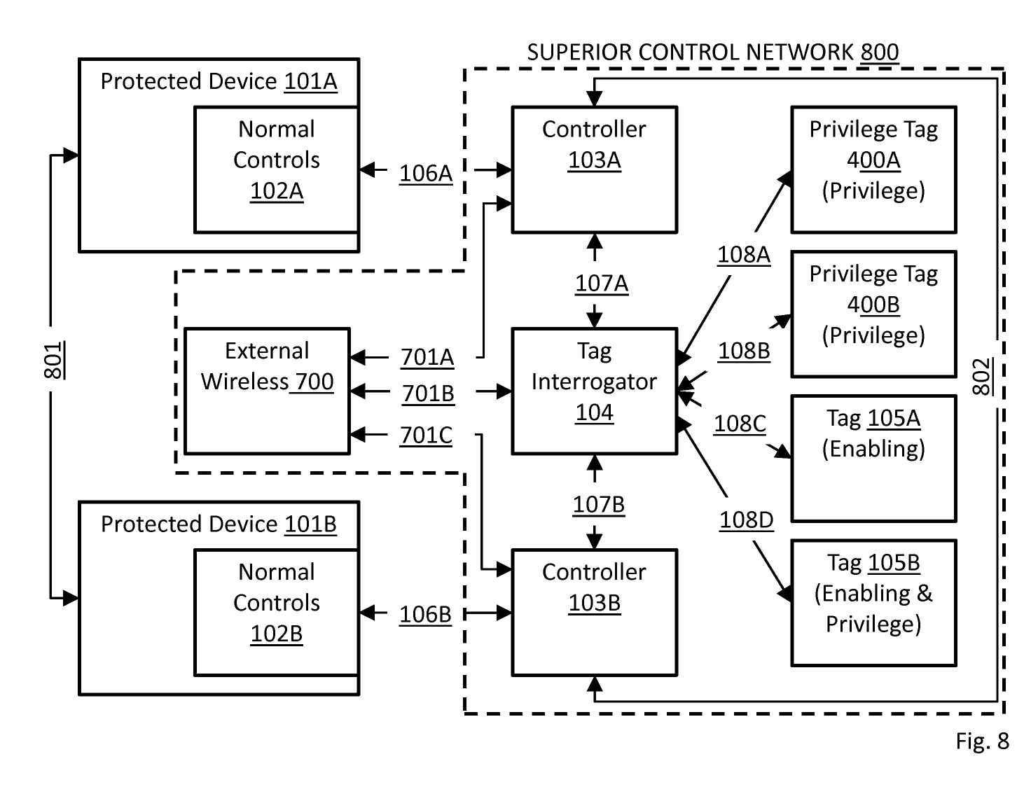

Communication channel 107A is the means by which controller 103A communicates with tag interrogator 104. In FIG. 7, tag interrogator 104 is drawn as a single entity to enhance the readability of the figure. However, FIG. 7 also includes architectures in which there are multiple interrogators, and in which these interrogators are not necessarily linked one to one with protected devices 101A, 101B, and other. In other words, FIG. 7 includes cases of multiple interrogators providing different levels of enablement and privilege to multiple protected devices, as would be clear to one skilled in the art. This also applies to FIG. 8.

Communication channel 107B is the means by which controller 103B communicates with tag interrogator 104.

Communication channels 108A, 108B, 108C, 108D is the means by which tag interrogator 104 communicates with privilege tag 400A, 400B, tag 105A, 105B respectively.

Tag interrogator 104 is capable of receiving instructions from controller 103A and/or 103B, and communicating with tag 105A and/or tag 105B, if within communication range.

Tag 105A, 105B are a device that are capable of communicating with tag interrogator 104, if within communication range. Tag 105A, 105B are programmable to include data such as, but not limited to, a tag identification number, a user identification number, and other data that can be used by the superior control network 100 to control protected device 101A and/or 101B via normal controls 102A and/or 102B respectively. In FIG. 7, tag 105A, 105B are tags that are configured as enabling tags. An enabling tag will allow the unrestricted access and use of any protected device 101A and/or 101B.

Privilege tag 400A, 400B are devices that are capable of communicating with tag interrogator 104, if it is within communication range. Privilege tag 400A, 400B are programmable to include data such as, but not limited to, a tag identification number, a user identification number, and other data that can be used by the superior control network 700 to control use of the protected device 101 via normal controls 102.

When tag 105A and/or 105B and/or privilege tag 400A and/or 400B are detected by tag interrogator 104, controller 103A and/or 103B can be actuated, as previously described. In this embodiment, however, tag 105A, 105B provides protection against unauthorized removal or usage, and separate privilege tag 400A and/or 400B allows for different privileges for use of protected device 101A and/or 101B to be programmed for each individual user.

FIG. 7 also includes an access point, external wireless 900. This access point can be a non-RFID hub, switch, router, femto-cell, cell tower, Wi-Fi router, My-Fi router, etc. External wireless is the primary means by which super control network 700 can be connected to the Internet cloud, etc. External wireless communicates via communications channels 701A, 701B, 701C with controller 103A, tag interrogator 104, and controller 103B respectively.

FIG. 8 is an illustration of alternative embodiment of the present invention.

Protected device 101A, 101B is any device, or machine that can be configured to work with superior control network of the present invention.

Normal controls 102A, 102B are the normal controls that are used to operate a device, or machine, but which are also configurable to work with the superior control network of the present invention.

The superior control network 800 of the present invention consists of the following items:

Controller 103A, which is the interface point of the present invention with normal controls 102A and protected device 101A. Controller 103A is designed to communicate with normal controls 102A, and tag interrogator 104.

Communication channel 106A is the means by which controller 103A communicates with normal controls 102A.

Controller 103B, which is the interface point of the present invention with normal controls 102B and protected device 101B. Controller 103B is designed to communicate with normal controls 102B, and tag interrogator 104.

Communication channel 106B is the means by which controller 103B communicates with normal controls 102B.

Communication channel 107A is the means by which controller 103A communicates with tag interrogator 104.

Communication channel 107B is the means by which controller 103B communicates with tag interrogator 104.

Communication channels 108A, 108B, 108C, 108D is the means by which tag interrogator 104 communicates with privilege tag 400A, 400B, tag 105A, 105B respectively.

Tag interrogator 104 is capable of receiving instructions from controller 103A and/or 103B, and communicating with tag 105A and/or tag 105B, if within communication range.

Tag 105A, 105B are a device that are capable of communicating with tag interrogator 104, if within communication range. Tag 105A, 105B are programmable to include data such as, but not limited to, a tag identification number, a user identification number, and other data that can be used by the superior control network 100 to control protected device 101A and/or 101B via normal controls 102A and/or 102B respectively. In FIG. 7, tag 105A, 105B are tags that are configured as enabling tags. An enabling tag will allow the unrestricted access and use of any protected device 101A and/or 101B.

Privilege tag 400A, 400B are devices that are capable of communicating with tag interrogator 104, if it is within communication range. Privilege tag 400A, 400B are programmable to include data such as, but not limited to, a tag identification number, a user identification number, and other data that can be used by the superior control network 700 to control use of the protected device 101 via normal controls 102.

When tag 105A and/or 105B and/or privilege tag 400A and/or 400B are detected by tag interrogator 104, controller 103A and/or 103B can be actuated, as previously described. In this embodiment, however, tag 105A, 105B provides protection against unauthorized removal or usage, and separate privilege tag 400A and/or 400B allows for different privileges for use of protected device 101A and/or 101B to be programmed for each individual user.

FIG. 8 also includes an access point, external wireless 700. This access point can be a non-RFID hub, switch, router, femto-cell, cell tower, Wi-Fi router, My-Fi router, etc. External wireless is the primary means by which super control network 700 can be connected to the Internet cloud, etc. External wireless communicates via communications channels 701A, 701B, and 701C with controller 103A, tag interrogator or reader 104, and controller 103B respectively.

Furthermore, superior control network allows for controller 103A to communicate directly with controller 103B via communication channel 800.

As shown in FIG. 8, a system 801 may include one or more protected devices such as protected devices 101A, 101B. The system 801 may use the RFID tag encodings to emulate physical RFID tags and perform functions. The functions may permit for enabling functionality associated with the system (such as in the case of tags 105A, 105B). The functions may allow a privilege to be associated with the system (such as in the case of tags 400A, 400B, 105B). In some embodiments, this is accomplished without emulating an RFID transponder signal. Instead, the RFID tag encodings are communicated over a network such as over communication channels 701A, 701B, and 701C associated with a communications device 700 or access point. The controllers 103A, 103B may include a machine readable memory for storing an RFID tag encoding. Link 802 indicates that controllers 103A and 103B may communicate directly with each other.

It understood by one skilled in the art that every embodiment can include tags, master tags, and privilege tags that are re-programmable. Re-Programmable tags could be done locally by a consumer, such as changing “parental control” levels; at a retail or service center; or electronically, by the Internet, cell phone, Wi-Fi, or other contemporary technology by a centralized facility. Reprogramming could be done as a revenue source only; for service upgrades and downgrades; when protected devices are sold, upgraded, or downgraded; and for other functions well known to one skilled in the art.

Enabling and privilege tags, similarly can allow enablement or privilege based upon sensor inputs, such as environmental or position inputs, or by manually entered confirmations of enablement or privilege.

In all of these embodiments, there are advantageous implementations. For example, if RFID or emulated RFID is used, the RFID or emulated RFID portion should be so integrated into the hardware and software of the protected device that it is exceptionally difficult or impossible to override the protection by alteration of hardware, including jumper wires or circuits that always return a false indication of RFID and/or emulated RFID tag presence. All such technologies, including cryptographic keys, public key encryptions, and other devices known to those skilled in the art, can be used within the definition of this patent. The techniques of FIG. 1 through FIG. 8 described in the present invention can be implemented using EPC Global RFID standards, or with custom hardware and protocols, or with emulated RFID technology, which will be described in detail below in the present invention.

Although master tags are not depicted in all the Figures, it is understood that master tags may optionally be included in any embodiments described herein.

Furthermore, although not shown in FIGS. 1 through 8, it is understood by one skilled in the art that protected device 101, normal controls 102, controller 103, tag interrogator 104, tag 105, master tag 200, and privilege tag 400 can all be enabled to communicate directly with programs, computers, cell phones, controllers, servers, switches, routers, hubs, other devices, such as but not limited to, cash registers, ATM machines, smart grid controllers, garage door openers, automobiles, etc., that are remotely located, and which are working in a cooperative manner with the present invention. The means of outside communication can be wireless, wired, acoustic, light, etc.

### Additional Technologies Useful in the Present Invention

The following describes various technologies that may be employed in accordance with best quality practices to meet the stated goal of the present invention. The following technologies can be employed in conjunction with the present invention in order to meet the stated goal of the present invention.

XML (eXtensible Markup Language). XML is extensively used in the world of computing. XML is a set of rules for encoding documents electronically. It is defined in the XML 1.0 Specification produced by the W3C and several other related specifications, which are fee-free open standards.

XML's design goals emphasize simplicity, generality, and usability over the Internet. It is a textual data format, with strong support via Unicode for the languages of the world. Although XML's design focuses on documents, it is widely used for the representation of arbitrary data structures, for example in web services.

There are many programming interfaces that software developers may use to access XML data, and several schema systems designed to aid in the definition of XML-based languages.

In a web-service quality system employed in support of the stated goal of the present invention, XML would be used as a means of generating standardized documents that can be exchanged, and used to enter and retrieve data from back-end systems.

The key to XML for any specific purpose is the development of an accepted schema for a particular application.

In addition to XML as a ubiquitous data presentation and interchange technology is the whole concept of cascading style sheets.

The present invention can use XML as a programming language to enable the seamless interchange of information between devices, and the seamless display on various disparate devices as well.

Cascading style sheets (CSS). CSS is a style sheet language used to describe the presentation semantics (that is, the look and formatting) of a document written in a markup language. Its most common application is to style web pages written in HTML and XHTML, but the language can also be applied to any kind of XML document, including SVG and XUL.

CSS is designed primarily to enable the separation of document content (written in HTML or a similar markup language) from document presentation, including elements such as the layout, colors, and fonts. This separation can improve content accessibility, provide more flexibility and control in the specification of presentation characteristics, enable multiple pages to share formatting, and reduce complexity and repetition in the structural content (such as by allowing for table-less web design). CSS can also allow the same markup page to be presented in different styles for different rendering methods, such as on-screen, in print, by voice when read out by a speech-based browser or screen reader, and on Braille-based, tactile devices. While the author of a document typically links that document to a CSS style sheet, readers can use a different style sheet, perhaps one on their own computer, to override the one the author has specified.

CSS specifies a priority scheme to determine which style rules apply if more than one rule matches against a particular element. In this so-called cascade, priorities or weights are calculated and assigned to rules, so that the results are predictable.

The CSS specifications are maintained by the World Wide Web Consortium (W3C). Internet media type (MIME type) text/css is registered for use with CSS by RFC 2318 (March 1998).

The main point of discussing CSS is that it is a ubiquitous technology that can be employed in conjunction with the present invention to provide a unique method of displaying quality records, consumer information, etc. that use XML, RFID information, barcode information, etc.

The present invention can use CSS to control the display on devices used in conjunction with the present invention, such as, but not limited to, laptops, cell phones, net books, notebooks, PCs, etc.

Barcodes. A barcode is an optical machine-readable representation of data, which illustrates certain data on certain products. Originally, barcodes represented data in the widths (lines) and the spacing of parallel lines, and may be referred to as linear or 1D (1 dimensional) barcodes or symbologies. They also come in patterns of squares, dots, hexagons and other geometric patterns within images termed 2D (2 dimensional) matrix codes or symbologies. Although 2D systems use symbols other than bars, they are generally referred to as barcodes as well. Barcodes can be read by optical scanners called barcode readers, or scanned from an image by special software. The barcodes for use in conjunction with the present invention may be printed or video displayed.

Printed and/or video displayed bar codes can be used to generate emulated RFID tags, as an example.

Hashing. A hash function is any well-defined procedure or mathematical function that converts a large, possibly variable-sized amount of data into a small datum, usually a single integer that may serve as an index to an array. The values returned by a hash function are called hash values, hash codes, hash sums, checksums or simply hashes.

Hash functions are mostly used to speed up table lookup or data comparison tasks—such as finding items in a database, detecting duplicated or similar records in a large file, finding similar stretches in DNA sequences, and so on.

A hash function may map two or more keys to the same hash value. In many applications, it is desirable to minimize the occurrence of such collisions, which means that the hash function must map the keys to the hash values as evenly as possible. Depending on the application, other properties may be required as well. Although the idea was conceived in the 1950s, the design of good hash functions is still a topic of active research.

Hash functions are related to (and often confused with) checksums, check digits, fingerprints, randomization functions, error correcting codes, and cryptographic hash functions. Although these concepts overlap to some extent, each has its own uses and requirements and is designed and optimized differently. The HashKeeper database maintained by the American National Drug Intelligence Center, for instance, is more aptly described as a catalog of file fingerprints than of hash values.

The present invention defines a hash function as a data comparison tool, a look-up tool, a checksum, a check digit, a fingerprint, a randomization function, an error correcting code, and a cryptographic hash.

Hashing can be used by the present invention to provide security.

Sensors. A sensor is a device that measures a physical quantity and converts it into a signal which can be read by an observer or by an instrument. For example, a mercury-in-glass thermometer converts the measured temperature into expansion and contraction of a liquid which can be read on a calibrated glass tube. A thermocouple converts temperature to an output voltage which can be read by a voltmeter. For accuracy, all sensors need to be calibrated against known standards.

The present invention may use sensors in conjunction with non-emulated RFID tags and/or emulated RFID tags to increase privilege and enablement capabilities for protected systems.

SMS. Short Message Service (SMS) is a communication service component of the GSM mobile communication system, using standardized communications protocols that allow the exchange of short text messages between mobile phone devices. SMS text messaging is the most widely used data application in the world, with 2.4 billion active users, or 74% of all mobile phone subscribers. The term SMS is used as a synonym for all types of short text messaging, as well as the user activity itself, in many parts of the world.

SMS as used on modern handsets was originally defined as part of the Global System for Mobile Communications (GSM) series of standards in 1985 as a means of sending messages of up to 160 characters, to and from GSM mobile handsets. Since then, support for the service has expanded to include other mobile technologies such as ANSI CDMA networks and Digital AMPS, as well as satellite and landline networks. Most SMS messages are mobile-to-mobile text messages, though the standard supports other types of broadcast messaging as well.

In the present invention, SMS also is defined as Multimedia Messaging Service, or MMS, is a standard way to send messages that include multimedia content to and from custom applications running on mobile phones. It extends the core SMS (Short Message Service) capability which only allowed exchange of text messages up to 160 characters in length.

The most popular use is to send photographs from camera-equipped handsets, although it is also popular as a method of delivering news and entertainment content including videos, pictures, text pages and ring tones.

The standard is developed by the Open Mobile Alliance (OMA), although during development it was part of the 3GPP and WAP groups.

As an example, the present invention can encapsulate RFID encodings in SMS text messages that can be used to enable cell phones to serve as emulated RFID tags. The use of cell phones allows enablement and privilege to be manually confirmed by the cell phone operator, using any of the techniques available on “smart” cell phones, including user interface manipulation or scanning bar codes or other encoded images. Wi-Fi. Wi-Fi is defined as the wireless technology of Wi-Fi Alliance. The Wi-Fi Alliance generally enforces the use of its trademark to describe only a narrow range of connectivity technologies including wireless local area network (WLAN) based on the IEEE 802.11 standards, device to device connectivity, such as, but not limited to Wi-Fi Peer to Peer a.k.a. Wi-Fi Direct, and a range of technologies that support PAN, LAN and even WAN connections.

As an example, the present invention can use WI-Fi as the communication channel in an emulated RFID system, where routers, cell phones, and computers are providing RFID capabilities and functions.

Mi-Fi. Mi-Fi is a line of compact wireless routers that act as mobile Wi-Fi hotspots. The Mi-Fi can be connected to a mobile phone (cellular) carrier and typically provide internet access for up to 5 devices. Mi-Fi works at a distance up to 10 m or 30 ft distance and will provide internet or network access to any Wi-Fi enabled PC, Apple Mac, Linux, Android, peripheral device, etc.

As an example, the present invention can use MI-Fi as the communication channel in an emulated RFID system, where routers, cell phones, and computers are providing RFID capabilities and functions.

Bluetooth. In the present invention Bluetooth is defined as the proprietary wireless technology, which is an open wireless technology standard for exchanging data over short distances (using short wavelength radio transmissions) from fixed and mobile devices, creating personal area networks (PANs) with high levels of security.

As an example, the present invention can use Bluetooth as the communication channel in an emulated RFID system, where routers, cell phones, and computers are providing RFID capabilities and functions.

Digital Rights Management. In the present invention Digital Rights Management (DRM)is defined to mean term for access control technologies that can be used by hardware manufacturers, publishers, copyright holders and individuals to limit the usage of digital content and devices. The term is used to describe any technology that inhibits uses of digital content not desired or intended by the content provider. The term does not generally refer to other forms of copy protection which can be circumvented without modifying the file or device, such as serial numbers or key files. It can also refer to restrictions associated with specific instances of digital works or devices.

The present invention can use DRM as a means of granting privilege and enablement from media content owners to users.

A general description of the present invention, a preferred embodiment, and alternative embodiments and aspects of the present invention has been set forth above. Those skilled in the art to which the present invention pertains will recognize and be able to practice additional variations in the methods and systems described which fall within the teachings of this invention. Accordingly, all such modifications and additions are deemed to be within the scope of the invention, which is to be limited only by the claims, appended hereto.

What is claimed:

1. A method of emulating a physical RFID tag, the method comprising:
storing in a machine readable memory an RFID tag encoding;
communicating the RFID tag encoding to a system;
using the RFID tag encoding at the system to emulate the physical RFID tag and perform a function without emulating an RFID transponder signal.

2. The method of claim 1 wherein the function is to enable functionality associated with the system.

3. The method of claim 1 wherein the function is to allow a privilege associated with the system.

4. A method of using an RFID tag encoding to provide privilege, the method comprising:
communicating the RFID tag encoding to a system;
using the RFID tag encoding at the system to establish a privilege associated with the system.

5. The method of claim 4 wherein the RFID tag encoding is encoded in a physical RFID tag.

6. The method of claim 5 wherein the communicating being performed by reading the physical RFID tag with a tag reader.

7. The method of claim 4 wherein the step of communicating the RFID tag encoding comprises communicating the RFID tag encoding over a network to the system.

8. The method of claim 4 wherein the privilege provides for operation once the system is operational or enabled.

9. An apparatus for emulating a physical RFID tag, the apparatus comprising:
a machine readable memory configured to store an RFID tag encoding;
a communications device operatively connected to the machine readable memory, the communications device configured to communicate the RFID tag encoding to a system such that the apparatus provides for emulating the physical RFID tag without emulating an RFID transponder signal.
